(19) United States
(12) Patent Application Publication
(10) Pub. No.: US 2006/0071131 A1
(43) Pub. Date: Apr. 6, 2006

(54) Cruise control moddule mounting bracket

(76) Inventors: David Gene Young, Emporia, KS (US); Roy Wayne Monroe, Emporia, KS (US)

Correspondence Address: DAVID YOUNG, RT 5, BOX 55Y, EMPORIA, KS, 66801, US

(21) Appl. No.: 10/958,810

(22) Filed: Oct. 5, 2004

(51) Int. Cl. F16M 11/00

(52) U.S. Cl. 248/200

(57) ABSTRACT

The present invention is a cruise control module mounting bracket designed to fasten a cruise control module to a vehicle, when no such mounting provision has been previously available.

### FIELD OF THE INVENTION

A mounting bracket for installing the cruise control module on a vehicle, when no such mounting provision has been previously available.

### BACKGROUNG OF THE INVENTION

Some vehicles have not been designed to accept cruise control. There is not a designated place to mount the cruise control module on these vehicles. This cruise control module mounting bracket invention allows some cruise control modules to be mounted on specific vehicles that the mounting bracket is designed for.

### SUMMARY OF THE INVENTION

The herein described cruise control module mounting bracket is one part of an installation kit containing multiple parts, to mount the vehicle manufacturer's electronic “brain”/throttle control, commonly know as the cruise control module. The cruise control module itself is not part of this invention. This invention is unique in that it uses the cruise control module already available from the vehicle manufacturer for their other models, but not offered on all models. As an example: Harley Davidson offers cruise control for its' “touring” models only, not for its' other models; Softail, Dyna, Vrod, or Sportster. This invention, cruise control module mounting bracket, will enable the cruise control module to be mounted on some or all of these and other vehicle models relevant to each mounting bracket design. This invention, the cruise control module mounting bracket is not currently available anywhere.

### BREIF DESCRIPTION OF THE DRAWINGS

FIG. 1 is a general example of the cruise control module mounting bracket, in accordance with an embodiment of the present invention, not to scale. Shape and dimensions will vary depending on brand and model of vehicle, and vehicle manufacturer's vendor supplying the cruise control module.

FIGS. 2 through 9 are detailed examples of the cover showing various views and dimensions of the preferred embodiment. However size and shape will vary depending on the specific application.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms and employed herein, they are used in a generic and descriptive sense only and not for the purpose of limitation.

The following paragraphs describe the cruise control module mounting bracket.

The Bracket

In a preferred embodiment the bracket will be shaped from a material such as steel, aluminum, plastic, fiberglass or other material so as to form shape that will enable fastening the cruise control module to the bracket and the bracket to the vehicle. The specific order of the fastening could be either fasten the bracket to the vehicle first and then fasten the cruise control module to the bracket, or fasten the cruise control module to the bracket and then fasten the bracket to the vehicle.

In a preferred embodiment the cruise control module will be fastened to the mounting bracket with bolts and the bracket then fastened to the vehicle with bolts. In an alternative embodiment, any method of fastening such as but not limited to screws, rivets, glue, etc. may be used and fastening in any order may be used.

### BRIEF DESCRIPTION OF THE DRAWINGS

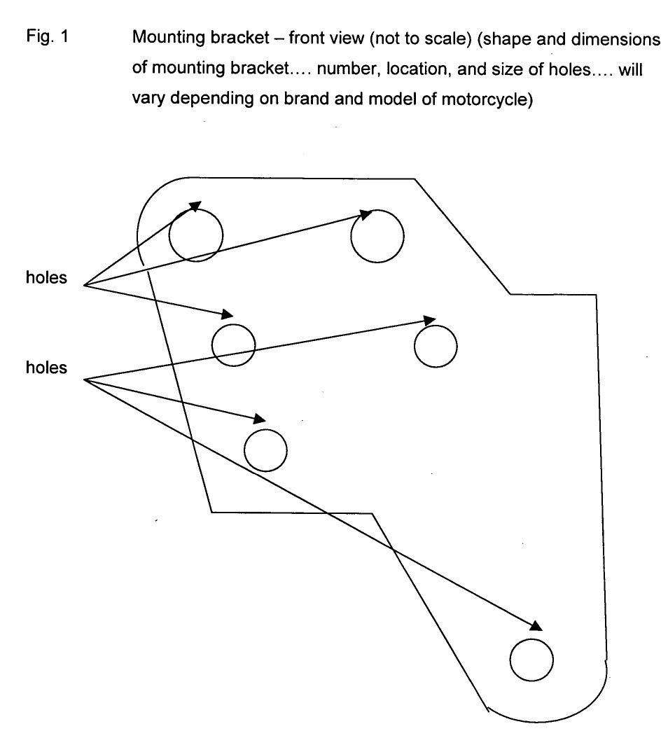

FIG. 1 is an example of a preferred cruise control mounting bracket front view, but is only representative of one of many designs that will be readily apparent that may be designed for specific installation requirements, depending of specific vehicle manufacturer, vehicle model or year of manufacturer, or manufacturer's vendor that supplies the cruise control module(s).

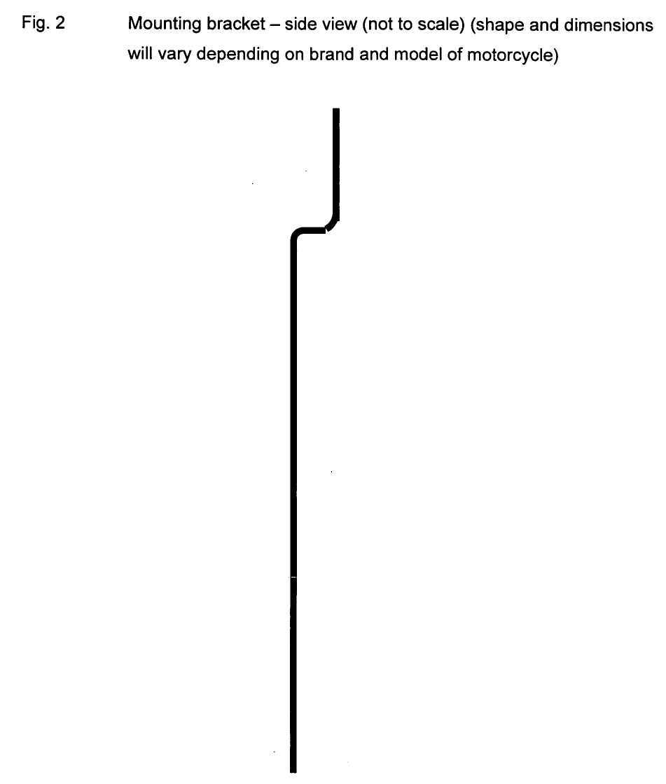

FIG. 2 is an example of a side view of the cruise control module mounting bracket.

1. A cruise control module mounting bracket designed to fasten a cruise control module to a vehicle, when no such mounting provision has been previously available as of the date of this filing.
